(19) United States
(12) Patent Application Publication
(10) Pub. No.: US 2014/0089009 A1
(43) Pub. Date: Mar. 27, 2014

(54) Method for Personal Genome Data Management

(71) Applicant: Wobblebase, Inc., Camden, DE (US)

(72) Inventors: Wim Van Criekinge, Waarloos (BE); Geert Trooskens, Gent (BE)

(73) Assignee: Wobblebase, Inc., Camden, DE (US)

(21) Appl. No.: 14/039,860

(22) Filed: Sep. 27, 2013

Related U.S. Application Data
(60) Provisional application No. 61/706,545, filed on Sep. 27, 2012.

(51) Int. Cl. G06F 19/00

(52) U.S. Cl. CPC G06F 19/322
USPC 705/3

(57) ABSTRACT

A method for personal genome information management includes receiving personal genome sequence data at a mobile device. The personal genome sequence data is compared to a reference genome sequence data to identify one or more sequence variants from the personal genome sequence data. One or more sequence variants from the personal genome sequence data are assigned to categories of hierarchical lists. One or more visual displays are provided to the user based upon the assignment of the sequence variants in the categories of hierarchical lists.

### CROSS REFERENCE TO RELATED APPLICATION

This application claims the benefit of U.S. Provisional Application No. 61/706,545, filed Sep. 27, 2012, which is incorporated by reference herein in its entirety.

### BACKGROUND

The present disclosure relates generally to methods and systems for personal genome data management. The method and systems allows for quick interpretation and actionable information.

A lot has been learned about individual variation through The Human Genome Project, completed in 2003. The human genome has approximately 3×10⁹ base pairs of DNA, and, although the human genome sequence is almost exactly the same (99.9%) in all people, a millions of locations where DNA differences occur in the genome have been identified. These differing polymorphisms tell us about differences between individuals. Most variation is meaningless and does not affect our ability to survive or adapt. Some variations are meaningful and do influence our ability to survive or adapt. Certain variations make us likely to develop a condition e.g. diabetes, heart disease, cancer, and so on. The 0.1% of unique DNA, plus the interaction of genetic and environmental factors, is what leads to our different phenotypic features, human traits and human condition.

Recent advances in sequencing and genotyping technology have greatly improved the understanding of the genetic basis of human visible traits (health, disease, intelligence, behavior, aging, metabolism, ancestry, etc. . . . ). Presently, one can have its genome analyzed through a personal genomic company and will receive its results back shortly. A growing number of companies are marketing genetic testing kits directly to consumers, people who aren't necessarily ill or at high risk for a disease, but who may be just curious or concerned about their risk for different disorders. Some of these tests are sold directly to consumers on the Internet.

Companies active in the field of genome analyses make sequence information most often available through variation data files in a computer readable format. Such files typically inform about the all or not presence of a variation at a particular position in the genome. The problem with the sequencing and genotyping approach is oftentimes that costumers are provided with a wealth of genomic data including a lot of noise (variant sequence) that probably is meaningless and not associated with a particular phenotype or condition. Thus, subsequent analyses are required that correlate an individual's variant sequence information with particular traits or conditions.

Web applications that are part of a website allowing individuals to view their genetic data and other personal data have been developed (e.g. 23andMe Inc and DeCODE Genetics, Knome). These web applications offer online access to computing systems, allowing extraction of meaningful information out of a personal genomic sequence. The systems combine genetic and phenotypic information and apply mathematical methods to report about a carrier status or to predict a relative risk (increased chance) of developing some trait or condition. For instance, the risk calculation may involve the development of heart disease, colon cancer, Alzheimer's disease, or other diseases, or the information may simply relate to a carrier status for pregnancy planning such as cystic fibrosis. Some web applications also identify genetic variants that increase or decrease your ability to metabolize certain drugs and indicate patient non-compliance with recommended medical treatments. Certain applications in addition allow for ancestry tracking by identifying clusters of gene variations that are often inherited by a group of people with a common origin. Still others allow interaction with the costumers, comment on a subset of their genetic and other personal data, and provide recommendations to guide the costumer through a healthier life.

Although all these recent advances have greatly improved personal genome data management and understanding, the methods applied still lack flexibility. A major general limitation of a web application is the requirement of a network connection, network availability, as well as the poor user experience and lack of education on the tools offered by the web application. Most people lead busy lives and have to fit their second level activities into spare moments, meaning that easy and rapid access to the genetic and other personal data, to be taken anywhere, would offer an advantage and improve knowledge and experience. Thus, there is the important issue of convenience. Second, the present web applications do not offer to the costumer a means or mechanism to analyse their genome information in depth beyond the variations offered to be associated with a particular treat. The computing systems applied may not always compare. For example, for type2 Diabetes, some web applications compute for 21 correlated gene variants, whereas others test only for 10 correlated gene variants. Thus, in particular cases, a costumer may want to improve the depth of the analysis of an existing personal variation not tracked by the applied web application. Third, although certain web applications allow sharing of personal genetic information with others, there is most often a limitation in sharing outside the network or survey offered by the web application. Fourth, certain variations which are currently not genetic markers may become associated to a condition or trait over time. As research continues to reveal new correlations between genotypes and phenotypes, there is an upcoming need for an application allowing costumer-driven adjustment of variant assignments based on fresh and novel information from secondary data sources (conferences, novel scientific papers, etc. . . . ).

There is thus a need for a quicker and more dynamic way to acquire, organize, sort or browse, and present personal genomic data and to filter the data for meaningful information and actionable feedback. There is a further need for a tool allowing personal management of the personal genome information. There is a further need for customer-driven adjustment and annotation of variant assignments. A further need exists in having the genomic data presented in a clear, transparent and user friendly manner.

### BRIEF DISCLOSURE

The general object of the present invention is to provide a software, service and system suitable for personal genome data management, for the personal management of the genome information, for the quick interpretation of a genome sequence, for getting more relevant and/or actionable information. The present invention overcomes shortcomings of the conventional art and may achieve other advantages not contemplated by the conventional software and services.

In general terms, it is an aspect of the invention to provide a method for managing personal genome information from a user on a mobile device. The method allows assignment of variants to lists including sequence variants associated with similar phenotypic conditions or traits. Preferably, the method allows for personal management including addition, omission, sharing and annotation of particular variants, traits or condition and generating customized or personal lists of sequence variants. In all embodiments, the method is providing one or more visual displays to the user that has data based on the assignment of the sequence variants in the categories of hierarchical lists.

In one embodiment, the method for managing personal information from a user on a mobile device comprises the steps of receiving or uploading or importing personal genome sequence data/variation file from the user; processing the personal genome sequence data/variation file from the user; assigning one or more sequence data/variations from the personal sequence data/variation file to categories of hierarchical lists; and providing one or more visual displays to the user that has data based on the assignment of the sequence variants in the categories of hierarchical lists.

In one embodiment, the method for managing personal information from a user on a mobile device comprises the steps of exploring; and/or comparing; and/or annotating; and/or sharing personal genome data; and/or providing enhanced interpretation of personal genome information; and/or getting actionable feedback.

In one embodiment, the step of managing personal information from a user includes exploring and/or comparing the personal genome sequence variation data from the user with published and functional sequence variant information, which sequence variant information is all or not associated with a phenotypic condition or trait.

In one embodiment, the step of managing personal information from a user includes annotating and/or sharing and/or providing enhanced interpretation of personal sequence variant information, which sequence variant information is all or not associated with a phenotypic condition or trait.

In one embodiment, the step of managing includes assigning one or more sequence variations from the sequence data/variation file to categories of hierarchical lists. The assignment is based on matches of one or more personal sequence variants with sequence variant information associated with a phenotypic condition or trait. In certain embodiments, similar phenotypic conditions or traits in a category of lists are ranked according to personal probability over population probability.

In one embodiment, the categories of lists are predefined or customized, and/or nested or hierarchical, and/or searchable. Predefined categories of lists include sequence variants associated with similar phenotypic conditions or traits. Customized categories of lists summarize personal observations linked to particular personal variants and apply local probability statistics.

In certain embodiments, the categories of lists include enhanced interpretation of sequence variants associated with similar phenotypical conditions or traits.

In one embodiment, the categories of lists are novel categories of lists generated from/based on predefined lists.

In a further embodiment, the step of processing includes sharing personal genome data and/or getting actionable feedback and/or providing enhanced interpretation of personal genome information. In a further embodiment, the step of processing includes annotating one or more sequence variations from the sequence data/variation file. In a further embodiment, the method allows to plug-in to social media.

It is also an aspect of the invention to provide for accessible personal genome information from a user on a mobile device which information is configured to receive input or output information about a sequence variant, and which information is managed according to the steps of the methods described herein.

It is a further aspect of the invention to provide a mobile apparatus for managing a personal genome information, said apparatus performing the method step described herein.

It is a further aspect of the invention to provide a computer program product on a computer readable storage medium in a mobile device, which program executes the steps of the methods of the present invention.

In particular the invention provides a method for managing personal genome information from a user on a mobile device, which method comprises the steps of
receiving personal genome sequence data/variation file from the user;
exploring and/or comparing the personal genome sequence data/variation file from the user
assigning one or more sequence data/variations from the personal sequence data/variation file to categories of hierarchical lists; and
providing one or more visual displays to the user based on the assignment of the sequence variants in the categories of hierarchical lists.

In particular embodiments, the method the step of receiving personal genome sequence data/variation file from the user comprises uploading or importing a personal genome sequence data/variation file from the user.

In particular embodiments, the personal genome sequence/variation file is received via encrypted communication and optionally stored in encrypted format in the mobile device.

In particular embodiments, the step of exploring and/or comparing the personal genome sequence data/variation file from the user comprises searching the personal genome sequence data/variation file for the presence of sequence variants all or not associated with a phenotypic condition or trait.

In particular embodiments, the step of exploring and/or comparing the personal genome sequence data/variation file from the user comprises comparing/matching one or more sequence variants from the personal sequence data/variation file to sequence variant information all or not associated with a phenotypic condition or trait.

In particular embodiments, the sequence variant information is available from, or made available through, one or more public sources, databases, scientific publications, scientific reports, or social media.

In particular embodiments, the method comprises the further steps of calculating risk from odds-ratios between two groups of population.

In particular embodiments, the risk for developing a disease or trait is calculated.

In particular embodiments, the method comprises the further steps of annotating and/or sharing personal genome sequence data.

In particular embodiments, the method comprises the step of annotating one or more variants within the personal genome sequence data to improve the depth of the analysis.

In particular embodiments, the method comprises the step of annotating one or more variants within the personal genome sequence data to improve risk variation assessment.

In particular embodiments, the method comprises the further step of providing enhanced interpretation.

In particular embodiments, the method comprises the further step of providing or getting actionable feedback.

In particular embodiments, one or more variants are annotated with one or more hashtags.

In particular embodiments, the personal genome sequence data is shared using social media.

In particular embodiments, personal genome sequence data is a SNP or variant sequence.

In particular embodiments, the SNP or variant sequence is shared in the form of a hastag.

In particular embodiments, the public source for sharing is twitter.

In particular embodiments, the step of assigning one or more sequence data/variations from the personal sequence data/variation file to categories of hierarchical lists is based on local statistics applied on variants, traits, diseases.

In particular embodiments, the category of lists involve tweets about a variant.

In particular embodiments, the categories of lists include most recent one to twenty relevant tweets about a variant.

In particular embodiments, the mobile device is a smartphone.

In particular embodiments, the method comprises a first step of ordering a sequence analysis.

In particular embodiments, the step of ordering a sequence analysis comprises selecting a genomic provider and/or a technology for sequence analysis.

In particular embodiments, the method is a mobile system implemented method.

In one aspect, the invention concerns personal genome information from a user implemented on a mobile device, which information is configured to receive input or output information about a sequence variant, and which information is managed according to the steps of the methods according to any of the preceding claims.

In one aspect, the invention concerns a mobile device embodying a program implementing any of the preceding methods.

In one aspect, the invention concerns a computer program product on a computer readable storage medium in a mobile device, which program executes the steps of the methods of any of the preceding claims.

### BRIEF DESCRIPTION OF THE DRAWINGS

The invention, both as to its structure and its operation, will be best understood from the accompanying drawings, taken in conjunction with the accompanying description, in which similar reference characters refer to similar parts, and in which:

FIG. 1 is an exemplary representation of parts of a variation data file.

FIG. 2 is a block diagram of exemplary hardware architecture for implementing one embodiment.

FIGS. 3a and 3b provide exemplary representations of a visual display on a mobile device showing login requirements for securing privacy of the application.

FIG. 3c is an exemplary schematic showing of the filtering step and the step categorizing personal variants.

FIG. 4 is an exemplary representation of a visual display showing categories/genome circles of reference sequence data associated with similar traits.

FIG. 5A is an exemplary representation of a visual display showing processed data generating a personal composition, in the form of maps, in accordance with one embodiment (My origins).

FIG. 5B is an exemplary representation of a visual display showing processed data from a generated personal composition, in the form of a geographic map, in accordance with one embodiment (My origins).

FIG. 6 is an exemplary representation of a visual display showing processed data generating a personal composition, in the form of risk-heat maps, in accordance with one embodiment (Intelligence).

FIG. 7 is an exemplary representation of a visual display showing processed data generating a personal composition, in the form of risk-heat maps, in accordance with one embodiment (Allergic asthma).

FIG. 8 is an exemplary representation of a visual display showing a genome view and the positioning of certain genome data from an SNP list associated with a particular phenotype.

FIG. 9 is an exemplary representation of a visual display showing a hashtag on Twitter of an SPN associated with a particular phenotype.

FIG. 10 is an exemplary representation of a visual display showing a 3D representation associated with a particular phenotype.

FIG. 11 is an exemplary representation of a visual display showing processed data from a generated personal composition, in the form of a trait view map, in accordance with one embodiment (prostate cancer).

FIG. 12 is an exemplary representation of a visual display showing processed data generating a personal composition, in the form of risk-heat maps, in accordance with one embodiment (testicular cancer).

FIG. 13 is an exemplary representation of a visual display showing personal pharmacy (upper left), trait overview for my health (upper right) and login provision (lower left).

### DETAILED DISCLOSURE

The invention provides for a system for managing personal genome information and for the quick interpretation of a genome sequence. The method may be described in the general context of mobile device executable instructions. The system provides for managing, sharing and comparing personal genome information on a mobile device. The method also provides for exploring and tagging a genome for enhanced interpretation and actionable feedback.

The invention can be implemented in numerous ways, including as a method: an apparatus; a system; a composition of matter; a computer program product embodied on a computer readable storage medium in a mobile device; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention.

Embodiments will be discussed with reference to the accompanying Fig.'s, which depict one or more exemplary embodiments. Embodiments may be embodied in many different forms and should not be construed as limited to the embodiments set forth herein, shown in the Fig.'s, and/or described below. Rather, these exemplary embodiments are provided to allow a complete disclosure that conveys the principles of the invention, as set forth in the claims, to those skilled in the art. For the purpose of clarity, technical material that is known in the technical fields related to the invention has not been described in detail so that the invention is not unnecessarily obscured.

In general terms, embodiments as disclosed herein provide a method for managing personal genome information from a user on a mobile device, which method includes the steps of:
receiving/uploading/importing personal genome sequence data/variation file from the user;
exploring and comparing the personal genome sequence data/variation file from the user
assigning one or more sequence data/variations from the personal sequence data/variation file to categories of hierarchical lists; and
providing one or more visual displays to the user based on the assignment of the sequence variants in the categories of hierarchical lists.

Thus, a method and system for managing the personal genome information from a user on a mobile device is provided and includes a process whereby personal genetic information from the user is obtained and processed.

By ‘personal genome sequence information’ is meant information containing a whole genome sequence or parts thereof which is/are derived from one individual, in particular the user. Preferably, the personal genome sequence data is provided in the form of a variation file indicating sequence variation relative to a reference sequence. The variation file may indicate epigenetic variation. DNA methylation is such epigenetic change and has been show to be associated with almost every biological process.

The personal genome information or genetic data from the user contains information about the individual's genes based on genetic and/or epigenetic variations or markers. Genotyping is the process of determining which genetic variants an individual possesses. Epigenetic typing is the process of determining which epigenetic variants an individual possesses. Genotyping and/or epigenetic typing can be performed through a variety of different methods, depending on the variants of interest. In some embodiments, the user's genomic information may be substantially the complete genomic sequence of an individual. In other embodiments, the genomic profile may be part of the complete genomic sequence of an individual. In preferred embodiments, the personal genome information is received in the form of a genome variation list having one or more variants. Such lists typically inform about the all or not presence of a variation at a particular position in the genomic sequence of an individual. In all embodiments, the user or individual is a human.

Samples and Methods for Genotyping

Genetic data is generated from a genetic sample of an individual. Genetic samples of DNA or RNA can be isolated from a biological sample (e.g. bodily tissue or liquid) from the individual. Preferably, the sample is saliva and is taken with a swab. Genomic information can be generated from the genetic sample using any of several methods well know in the art, such as, but not limited to high density arrays and sequencing.

For looking at many different variants at once, especially common variants, genotyping “chips” or high density DNA arrays are an efficient and accurate option. These do, however, require prior knowledge of the variants you want to analyze. Such arrays are commercially available from, for instance, Affymetrix and Illumina (see for example, Affymetrix GeneChip 500K Assay manual, Affymetrix, Santa Clara, Calif.; Sentrix® human Hap650Y genotyping beadchip, Illumina, San Diego, Calif.).

Variants may be explored using sequencing technology. Sequencing is a method used to determine the exact sequence of a certain length of DNA. One can sequence a short piece, the whole genome, or parts of the genome by any of several methodologies (see Sanger et al. PNAS 74:5463-5467, 1977; Margulies et al. Nature 437:376-380 (2005); U.S. application Ser. No's. 11/167,046 (2005) and 11/118,031 (2005)). Depending on the location, a given stretch may include some DNA that varies between individuals, like SNPs or hypermethylation, in addition to regions that are constant. Thus, sequencing can be used to genotype someone for known variants, as well as identify variants that may be unique to that person.

DNA methylation is a chemical modification of DNA performed by enzymes called methyltransferases, in which a methyl group (m) is added to certain cytosines (C) of DNA. Aberrant methylation has been associated with certain human condition, such as the development of cancer. Methods for distinguishing methylation variants, more in particular distinguishing DNA methylation mark 5-methylcytosine (5 mC) from unmethylated cytosine (C), may be explored using technologies described in “Advances in genome-wide DNA methylation analysis”, Biotechniques V49 No. 4: iii-xi, 2010, The most robust method for studying cytosine covalent modification is bisulfite conversion followed by DNA sequencing. Treatment of the DNA with sodium bisulfite under the treatment conditions, leads to the conversion of unmethylated cytosine to uracil, while methylated cytosine (both 5mC or 5 hmC) remains unchanged. This change in DNA sequence following bisulfite conversion can be detected using a variety of methods.

Ordering

In one particular embodiment, the method for managing personal genome information from a user requires an ordering step through which the user selects the genomic provider and/or the technology for sequence analysis, and places the order for getting personal genome sequence information. The method may contain the steps of browsing through a list of genomic providers and/or a list of applicable technologies and making a selection. Available selections may amongst others comprise SNP investigation, exome sequencing, full sequencing, full diploid sequencing or epigenetic profiling. The system and method prove attractive to tap into client base or existing sequencing or genomic profiling companies. The system may require authentication information once an order is placed. In order to obtain the personal genome information, the user will provide the genomic provider with a suitable sample for analysis.

Sequence Variation File and Epigenetic Variation File

Genetic data most often is put available in the form of a genome variation list. Raw data following scanning high density array or all or not full sequencing is, with use of available software, turned into a raw genome variation list encoded in a computer readable format that can be accessed. Typically, the raw personal genomic sequence information is compared to one or more reference genome(s) and the variant matches and variant mismatches between the reference genome(s) and the personal genome are recorded in a list as a variant. Variation files may contain information on mutations, deletions, insertions, genetic rearrangements, polymorphisms, single-nucleotide polymorphisms (SNP's) and/or copy number variations and/or methylation variations.

“Polymorphisms” are differences in individual DNA which are not mutations.

“Mutation” refers to changes at the level of DNA. One or more base pairs may have undergone a change and a change may be at random or due to a factor in the environment.

“Copy number variation” refers to variation in the number of DNA repeats (i.e. AAGAAGAAGAAG)

“Single-nucleotide polymorphism (SNPs)” is a DNA sequence variation occurring when a single nucleotide—A, T, G or C in the genome differs between members of a species, or between paired chromosomes in an individual. AAGCCTA to AAGCTTA, contain a difference in a single nucleotide. In this case we say that there are two alleles: C and T. SNP's are the most common form of DNA sequence variation, occurring about once every 1,000 bases or so.

“DNA methylation” refers to a chemical modification of DNA performed by enzymes called methyltransferases, in which a methyl group (m) is added to certain cytosines (c) of DNA. This non-mutational (epigenetic) process (mC) is a critical factor in gene expression regulation (See, J. G. Herman, Seminars in Cancer Biology, 9: 359-67, 1999). By turning genes off that are not needed, DNA methylation is an essential control mechanism for the normal development and functioning of organisms. Alternatively, abnormal DNA methylation is one of the mechanisms underlying the changes observed with aging and development of many cancers.

“A reference genome”, also known as a reference assembly, is a digital nucleic acid sequence database, assembled by scientists as a representative example of a species' set of genes. They are often assembled from the sequencing of DNA from a number of donors and do not accurately represent the set of genes of any single individual. Instead a reference provides a haploid mosaic of different DNA sequences from each donor. For example GRCh37, the Genome Reference Consortiumhuman genome (build 37) is derived from thirteen anonymous volunteers from Buffalo, N.Y..

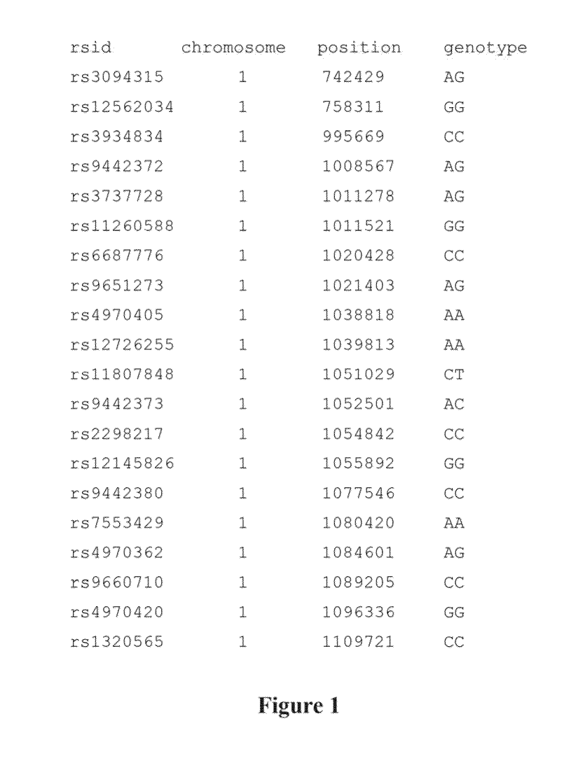

As an example, FIG. 1 is a representation of parts of a variation text file record received following high density array genotyping. Data are provided in fields which are TAB-separated. Each line corresponds to a single SNP. For each SNP, an identifier (an rsid or an internal id) is provided along with its location on the reference human genome and the genotype call oriented with respect to the plus strand on the human reference sequence. The rsID map to a unique genomic location and can be used for browsing the public genome information to spot reported public variants at that position. Depending on the provider, the record may include additional identifiers for characterizing the variation. The representation does not have to be limited to SNP's but can include other variations as described.

Data Transmission and Storage

The personal genome sequence management system that is described herein receives personal and public genome sequence information from input devices and other sources. Numerous sources can provide genome sequence information, including, but not limited to sequencing service providers and/or health care providers and/or users. The genome information may reside on files, in a file system, a database, a storage area network, a cloud-based storage service, and various other devices for storing information, including, but not limited to a computer or a personal USB drive. Various communication links may be used for data transmission, including, but not limited to point-to-point dial up connections or connections with local area networks, database entries, computer entries, device applications, read maps, servers, and so on. Encrypted communication and secure identification of a network web server may happen through, for instance, Hypertext Transfer Protocol Secure (HTTPS), SSL (Secure Socket layer).

The sequence variation entries may feed a large amount of information into the mobile system and the unit receiving and/or uploading the genome sequence information may need to store the information into the memory for further processing. Typically, the data resides on the mobile device in encrypted format. The data does not necessarily need to be stored on the mobile and, alternatively, an encrypted synchronization with central cloud based service may provide user access to the data. Alternatively, the data may reside on a computer. Alternatively, part of it may be on the mobile device itself, part of it may be in the cloud or computer that the mobile device would have access to. Thus the method for implementation on the mobile device may require these additional steps.

“Cloud computing” is the delivery or hiring of computing and storage capacity as a service to a community of end-recipients. Cloud computing entrusts services with a user's data, software and computation over a network. End users access cloud-based applications through a web browser or a light-weight desktop or mobile application while the Software and user's data are stored on servers at a remote location.

Mobile Device Implementing the Managing Method

The method for managing personal genome information will allow the further processing of the personal genomic data. The mobile device on which the managing system is implemented hereto includes a central processing unit, a graphics processing unit, an internal memory, input devices (e.g. keyboard, pointing devices, touch screen devices), output devices (e.g. display devices), storage devices and a data receiving and transmission medium, such as a signal on a communication link. Various communication links may be used, such as the Internet, social media (e.g. Twitter, Facebook, . . . ), a local area network, a wide area network, a point-to-point dial-up connection, and so on. Mobile devices have been designed for many applications and include mobile computers, smartphones, and tablet computers.

The method for implementation on the mobile device is available to the user in the form of an application (App) and can be downloaded to the mobile device via an application store which is a process well known in the art. Preferably, the mobile device is a mobile phone, more preferably a smartphone and the system is an application for managing personal genome sequence information on a smartphone. A mobile device leads to flexibility in working giving the power and convenience of quick internet and information access.

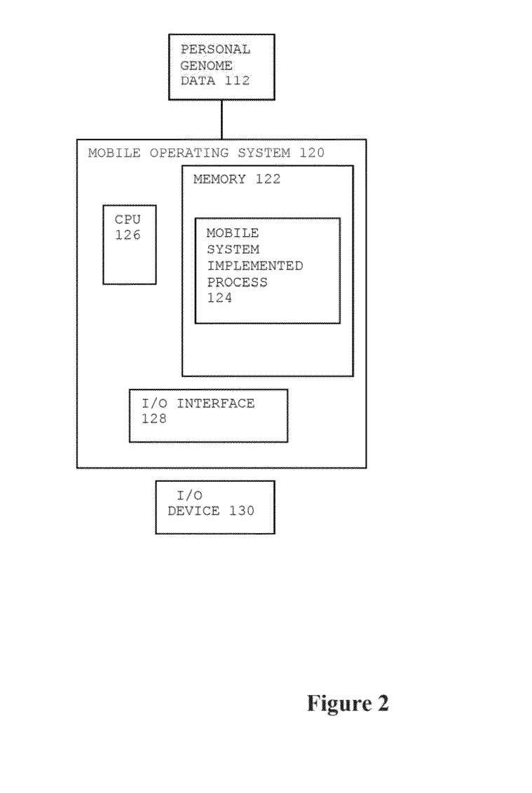

As an example, FIG. 2 is a block diagram of exemplary hardware architecture for implementing one embodiment of a method for personal genome data management, which includes uploading personal genome data from a user 112 on a mobile operating system 120. As seen in FIG. 2, mobile operating system 120 typically includes a memory system 122, a processor 126 and an input-output interface 128. In one embodiment, the mobile operating system 120 includes all or part of one or more mobile system implemented method 124, such as, but not limited to a personal genome management system that is used by, is a parent system for, is accessed by, and/or is otherwise associated with, a method for managing a personal genome information. The mobile operating system 120 further includes input-output devices 130, including a display device. The method for managing the personal genome sequence begins when the personal genome data 112 is obtained. In one embodiment, the personal genome sequence information will be uploaded and stored in the memory system 122 of the mobile device.

Encrypted

Personal genome sequence information should not be vulnerable to unauthorized access or disclosure that could lead to discrimination. Therefore, privacy of the information should be protected and it may require track of the user. For instance, users may perform an initial registration process during which the system collects or stores the personal sequence information, or the device may identify that the user previously registered with the system.

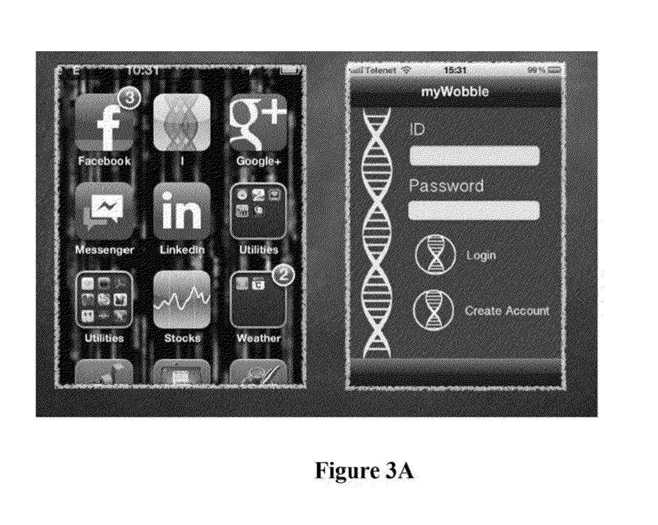

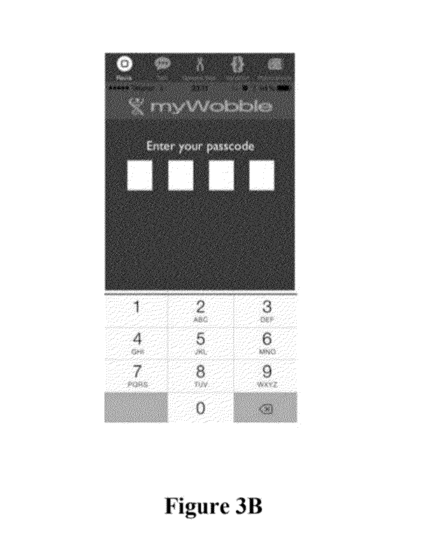

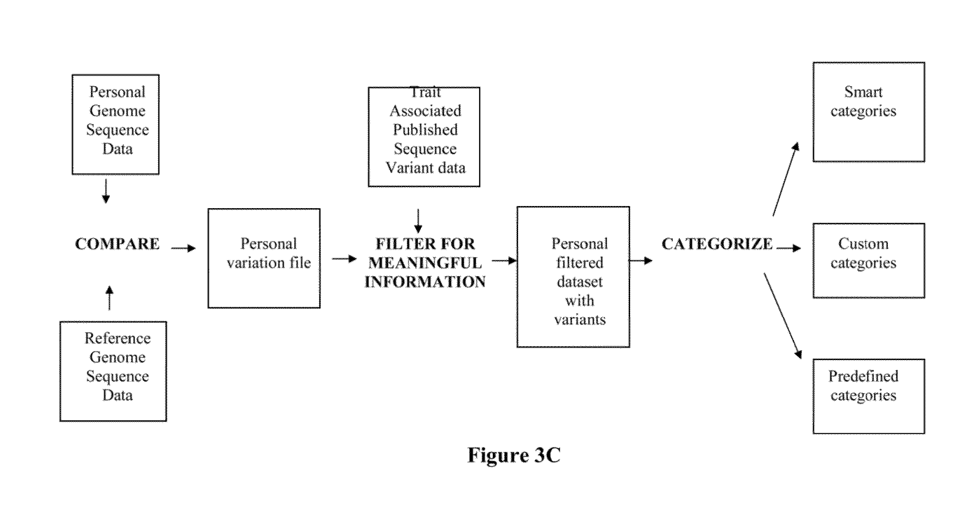

FIG. 3 is an exemplary representation of a visual display showing selectable applications and login requirements for securing privacy of the application. Upon selecting the App myWoble, the input may require a device identifier (DI) and the provision of a password in which the system identifies the user associated with the personal genome information in order to limit access by unauthorized users. In addition, the mobile and smartphone platform may have some kind of remote erase capability.

Processing of Data

Exploring Personal Genome Information

In one embodiment, the application for managing personal genome information includes the step of exploring the personal genome data. The variation data from the user is filtered for meaningful information. The steps of the method include browsing the personal genome sequence data/variation file from the user for the presence of one or more sequence variants associated with a phenotypic condition or trait. Published and functional sequence variant information associated with a phenotypic condition or trait is hereto compared with the personal genome sequence variation data from the user. The outcome is a personal filtered dataset, which is a table join. Alternatively, the functional sequence variant information does not necessarily issue from public information, but instead may be non-public information such as the one generated or obtained by own research, collaborators or labs estimating and interpreting variants, customers using the systems and methods of the invention, a network, a survey, or social media (e.g. twitter, facebook, google+, . . . )

One, two, three or more sources of information may be consulted for obtaining genotype-phenotype information as required. The information recorded will depend on whether a match across one or more sources was obtained. The personal filtered dataset may include for each individual distinctive variant, a variant identifier (an rsid or an internal id), the location on the reference human genome, the personal genotype call oriented with respect to a strand on the human reference sequence, and data retrieved from the trait associated published information such as, for example, reported risk variants genotype(s), associated gene name, associated phenotype, associated condition, physical state, odds ratio's, relative risk, lifetime risk, reference to the published data and more. This information may be provided to an output module for the individual to review its personal variants and may be subject to further categorization based on certain rules. By way of example, applicable rules may implement the listing of, for example, variants linked to a disease condition, common variants, rare variants, variants linked to European origin, etc. . . .

The published and functional sequence variant information used for meaningful information filtering may reside in a public database, or, alternatively be extracted from a public database or other communication means such as research papers, journal articles, social media. For instance, MedlinePlus, HapMap Project, Alfred Project, the Human Gene Mutation Database (HGMD), the Single Nucleotide Polymorphism database (HGMD), SNPedia and Ensembl provide SNP information or methylation information and enable examination of genetic risk factors underlying a wide range of diseases and conditions such as cancer, neurodegenerative diseases, cardiovascular diseases, infectious diseases, inflammatory diseases and others. Many other phenotypes such as mental traits (e.g. intelligence, memory performance, etc. . . . ), physical traits (e.g. height, weight, agility, etc. . . . ) emotional traits, age, ancestry can also be examined.

Further, sequence variants associated with a phenotypic condition or trait may be part of a dataset comprising a link to information about the phenotypic condition and information associated thereto such as genetic positional information, statistical information including incidence, population type, associated statistical risk, and so on. The method or system comprising such link my for instance be a distinctive database that links to all or part of the data and data-related information of another database, such as a public or commercial database. Thus, alternatively, the methods of the invention may use a distinctive database for meaningful information filtering.

As used herein, a ‘phenotype’ refers to certain observable characteristic or trait of an organism, such as morphological, developmental, biochemical, physiological, conditional or behavioral properties. Height, eye color, gender, personality characteristics and risk of developing certain types of cancer are examples of phenotypes.

Categorize Variants

As explained, the App implementing the methods of the invention allows users to retrieve meaningful individual genomic variations, methylation variations, their locations, and biological impacts. Variants associating personal sequence variants with phenotypic trait or condition may be categorized in categories of lists. Categories of genelists are beneficial since they speed up finding data. Traits or phenotypic conditions can be grouped in categories which are nested or hierarchical and searchable. In a genomic circle, similar traits are ranked according to personal probability over population probability. Per trait and/or per variant, custom notes can be made and exchanged.

By ‘category’ is meant a set of distinct genome variation giving rise to a visible trait or condition. The words category, genome circle and genelist as set forth herein have the same meaning and are interchangeable. Thus, genome variations may for instance be categorized under aging, behaviour, disease, health, intelligence, looks, ancestry, and so on.

The methods of the invention provide for categories of lists (or genomic circles) that are predefined categories of lists, categories of lists including enhanced interpretation (smart categories) or customized categories of lists. The lists can be hierarchical or nested. Some of the items in a hierarchical list can themselves be hierarchical lists. For instance, the category “Disease” may contain multiple disease lists. The disease list relating to a condition such as lung cancer may contain further sub-lists.

In one embodiment, the category of lists is a predefined category of lists and each list includes one or more sequence variants statistically associated with similar phenotypic conditions or traits. Assignment of one or more sequence data or variants to predefined categories of lists from the personal filtered dataset with variants is based on rules. For example, rules associated to the category Health for a condition such as obesity (BMIOB) may assign sequence variant information on SNP's rs9939609 and rs9291171 to the list representing obesity. Rules may assign SNP's rs4242384, rs6983267, rs16901979, rs 17765344 and/or rs4430796 to the category “Disease” for a condition such as prostate cancer. One variant or SNP may belong to one or more categories of hierarchical lists.

In one embodiment, predefined categories can be customized by the user to generate and share its own personal genotypic combination and/or to link to the phenotypic condition in a health information database.

In a further embodiment, the categories of lists include enhanced interpretation. Such smart lists are associated to a phenotypic trait and/or a condition in a health information database and/or to the ancestry of the user, and contain additional relevant information based on specified rules. The additional information may incorporate amongst others an identifier or link to the scientific report, a reported relative odds measure or statistical risk associated with the variant, a link to the phenotypic condition in health information database, personal notes, personal annotations and contain other tags.

Personal sequence data/variations associated with a phenotypic trait are thus assigned to categories of lists. Assigning rules can be made based on scientific research that demonstrates a correlation between a particular variant and a certain trait and/or condition and/or phenotype, or alternatively can be based on non-public information demonstrating such correlation, or alternatively can be based on both public and non-public information. Separate rules may be provided for incorporating factors that are specific to the user (for example ethnicity, gender, age, family medical history, personal medical history, and other phenotypes) and that could influence effect estimates.

Local statistics may be applied and may result in customized categories of lists. Customized categories of lists summarize personal observations linked to particular variants such as SNP or methylation site. For instance, categories of lists include variant (SNP or methylation site) of the day; most visited one, five, ten, fifteen, or twenty SNP variant(s); most recent one, five, ten, fifteen, or twenty commented variant(s); one, five, ten, fifteen, or twenty favorite variant(s); most recently one, five, ten, fifteen, or twenty added variant(s); last one, five, ten, fifteen, or twenty modified variant(s); top ranked variant, most recent one, five, ten, fifteen, twenty tweets on a particular variant; most recent one, five, ten, fifteen, twenty blogs on a particular variant; most recent one, five, ten, fifteen, twenty like variants; etc. . . . Further, categories of lists involve trait (disease, condition, . . . ) of the day; most visited trait; most commented trait; favorite trait, recently added trait; last modified trait; top ranked trait; etc. . . . Further, categories of lists involve probabilities; top five, ten, fifteen or twenty of most susceptible diseases; top five, ten, fifteen, or twenty of susceptible diseases; top five, ten, fifteen or twenty of high risk diseases; top five, ten, fifteen or twenty of low risk diseases; etc. . . . The categories of lists may involve a top of one, two, three, four, five, six, seven, eight, nine, ten, eleven, twelve, thirteen, fourteen, fifteen, sixteen, seventeen, eighteen, nineteen, or twenty diseases, traits, variants, tweets about one or more variants, blogs about one or more variants.

Output and Visualization

The method provides records based on the assignments of genomic variation in the categories of lists, and one or more visual display outputs based on the records are provided to the user. The system or method may provide a variety of list controls, such as controls for displaying only the information the user needs. Additionally, the system may remember user preferences. Hierarchical list boxes may be applied within an application in order to expand and collapse a hierarchy of information. A list or sub-list may be provided with a symbol such as an arrow that the user can click to hide or show the list's items.

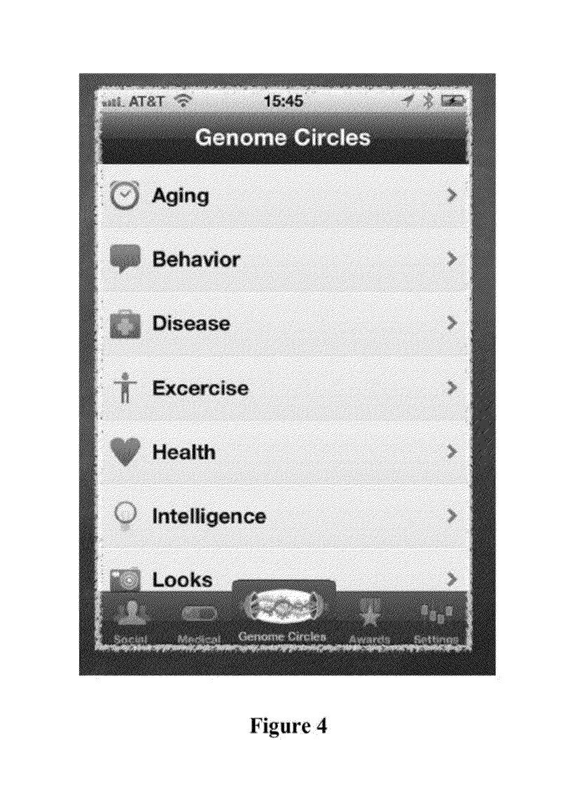

As an example, FIG. 4 is a representation of a visual display showing a browse window including different genome circles such as aging, behavior, disease, exercise, health, intelligence, looks, etc. . . . The browse window enables the user of the application program to browse through a plurality of (first) selectable categories or genome circles. Upon selection of a first category or genome circle by the user, a sub-window may open with one or more further lists of (second) selectable items. Further (third fourth and more) sub-lists are generated based on genetic markers or variants assigned to the selectable categories, providing information on a user's state. The state may for instance involve a trait, a condition and/or a treatment.

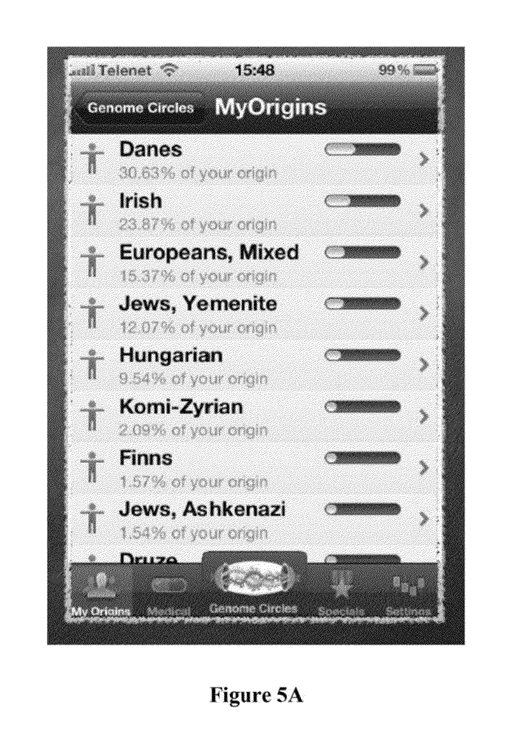

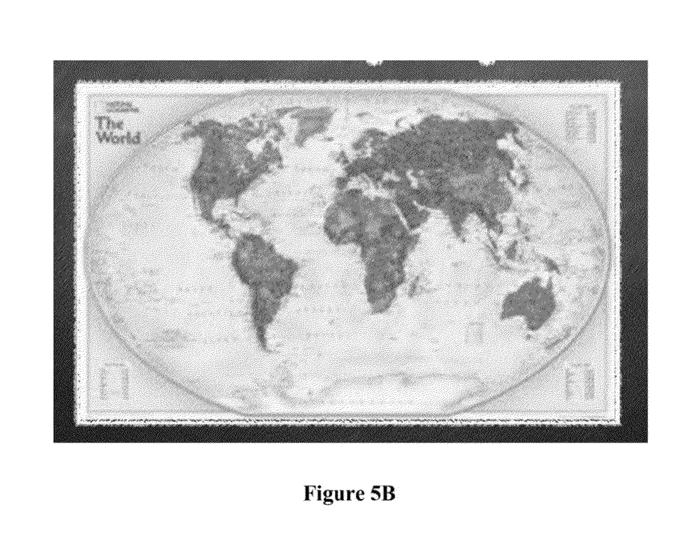

As an example, FIG. 5 is a representation of a visual display of a sub-window of the category ‘my origins’ (ancestry) providing a range of further selectable items (Danes, Irish, Europeans mixed, . . . ) providing information on where an individual's ancestors originated from.

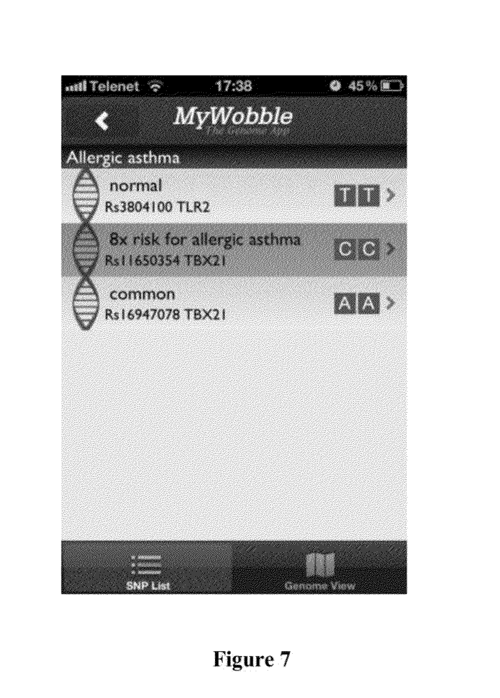

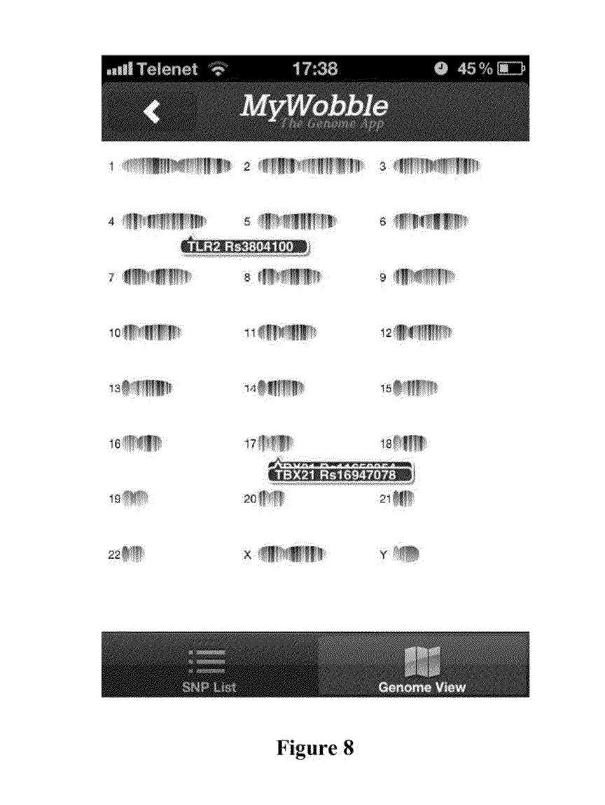

As another example, FIG. 7 is a representation of a visual display of a sub-window of the category ‘allergic asthma’ providing information on TLR2 Rs3804100. TBX21 Rs16947078 and TBX21 Rs11650354 SNP's. The window allows for the further selectable item Genome View. FIG. 8 is a visual display of a browse window showing the associated genome view and the positioning of certain genome data from an SNP list associated with a particular phenotype. In this particular case, the window relates to Allergic asthma, indicating TLR2 Rs3804100 linked to chromosome 4. Both TBX21 Rs16947078 and TBX21 Rs 11650354 are linked to chromosome 21. FIG. 1 is a representation of a visual display of a sub-window zooming in on the trait prostate cancer including a cellular view, a risk-heat mapping for different SNP's associated to the trait, and a description providing background information on the treat and associated SNP's. The window allows for the further selectable items: audiocommunication, chromosome linkage, variation details and public information (e.g. scientific publications) associated to the trait.

Selection of Risk Associated Genetic Variants (SNP's).

A set of distinct genome variation may associate to a trait or condition. In healthcare, genetic risk variants are most commonly discovered in so called case-control studies, i.e. where deviations in the genetic code are observed between a set of patients and a set of healthy controls. It is important that the association of SNP markers with a particular disease be widely replicated in independent populations from different medical centers or countries. Otherwise, there will be concern that the initial observation is not applicable beyond the study population, or more likely, is incorrect false positive risk association. Most of the disease associating markers currently used to assess risk have first been discovered and replicated in white populations of European descent, but some of the markers have also been replicated in other ethnic groups. Since the risk of a given variant can differ substantially between ethnic groups, independent replication and risk assessment must be carried out for each ethnic group.

Relative Risk of Developing a Condition

Disease risk is a way to describe how likely it is that a person will develop a particular disease. The chance that a person will develop a disease at some point during their lifetime is referred to as lifetime risk. Because the development of a disease can occur at different times in different people, risk is often calculated as an average among groups of people. The likelihood that a particular group of people will develop a disease compared to the average likelihood of developing the disease is called the relative risk.

Relative risk is calculated by comparing the risk in a group of individuals with certain characteristics against the risk of a control group (such as randomly selected individuals from the general population). For example, consider a group of individuals with high cholesterol, a known factor that increases the risk of developing heart disease. This group of individuals has a certain level of risk of developing heart disease that is higher than that of the general population—e.g. a 1.5-fold higher chance. This means that 50% more individuals in the high cholesterol group will develop heart disease than will individuals in the general population.

As individuals in the two groups are monitored over time to determine whether they actually develop heart disease, it may be observed that 52% more people, not the 50% expected, in the high cholesterol group have developed heart disease. The difference between the actual occurrence of the disease and calculated disease risk is based on many factors. It is thus important to realize that a relative risk is not a true value but only an estimate.

The relative risk of a given genetic variant to develop a trait can vary according to population and/or gender and/or age. For instance a SNP that has been validated for a specific trait in whites of European descent is not necessarily valid for African-American whites. Consequently, the input 101 may require a background identifier 110 in which the system identifies some background such as gender and/or ethnic group characteristics and/or age of the user associated with the personal genome information. This allows the processing unit to carry out independent replication and risk assessment for each ethnic group and/or gender and/or age.

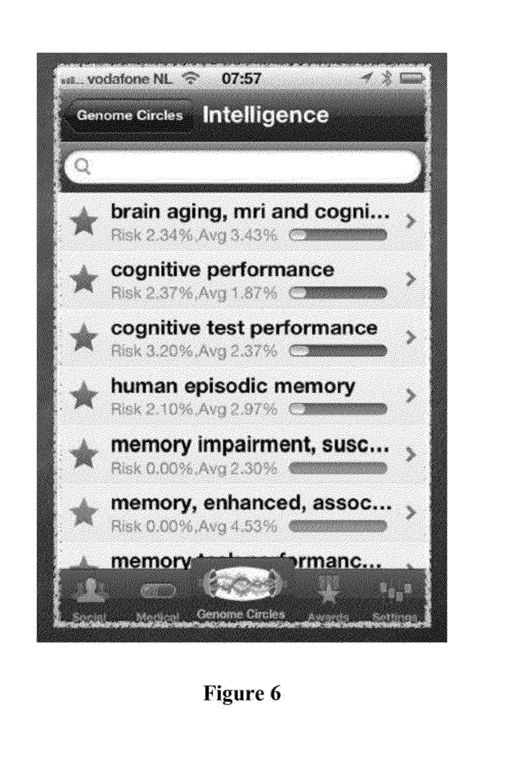

The system expresses the relative risk factor or predictive probability value in terms of maps. As an example, FIG. 5A is a representation of a visual display showing processed data generating a personal composition on ancestry in the form of maps. The map expresses the predictive probability value of traits in terms of percentages and a horizontal bar-representation. Each map represents a trait (Danes, Irish, . . . ). In another example, FIG. 6 is a representation of a visual display showing processed data generating a personal composition on intelligence in the form of risk-heat maps. The map expresses the risk factor for developing an intelligence trait in terms of percentages and horizontal bar-representations showing different colours depending on the risk grade. It is to be understood that additional properties or tags, such as for instance the SNP sequence, or recent literature may be part of the content of the map.

In still another example, FIG. 7 is a representation of a visual display showing processed data generating a personal composition on allergic asthma. The map expresses different sequence variations and the risk for developing allergic asthma in terms of a risk factor associated with a particular variant. The risk factor is emphasized by a colored background, attracting the attention of the viewer.

Risk Calculations—Deriving Risk from Odds-Ratios

A model to calculate the overall genetic risk involves two steps: i) conversion of odds-ratios for a single genetic variant into relative risk and ii) combination of risk from multiple variants in different genetic loci into a single relative risk value.

Retrospective studies for diseases sample and genotype people who have a specified disease condition (cases) and unaffected individuals (controls). The results are typically reported in odds-ratios, that is the ratio between the fraction (probability) with the risk variant (carriers, c) versus the non-risk variant (non-carriers, nc) in the groups of affected (A) versus the controls (C), i.e. expressed in terms of probabilities conditional on the affection status:

OR=(Pr(c|A)/Pr(nc|A))/(Pr(c|C)/Pr(nc|C))

The probability of individuals carrying the risk variant who get the disease is the absolute risk for the disease. This number cannot be directly measured in case-control studies, in part, because the ratio of cases versus controls is typically not the same as that in the general population. However, under certain assumption, the risk can be estimated from the odds-ratio. Calculation show that for the dominant and the recessive models, with a risk variant carrier, “c”, and a non-carrier, “nc”, the odds-ratio of individuals is the same as the risk-ratio between these variants:

OR=Pr(A|c)/Pr(A|nc)=r

Likewise for the multiplicative model, where the risk is the product of the risk associated with the two allele copies, the allelic odds-ratio equals the risk factor:

OR=Pr(A|aa)/Pr(A|ab)=Pr(A|ab)/Pr(A|bb)=r

“a” denotes the risk allele and “b” the non-risk allele. The factor “r” is the relative risk between the allele types.

For many of the studies published in the last few years, reporting common variants associated with complex diseases, the multiplicative model has been found to summarize the effect adequately and most often provide a fit to the data superior to alternative models such as the dominant and recessive models.

Risk Calculations—the Risk Relative to Average Population Risk

It is most convenient to represent the risk of a genetic variant relative to the average population since it makes it easier to communicate the lifetime risk for developing the disease compared with the baseline population risk. For example, in the multiplicative model the relative population risk for variant “aa” can be calculated as:

RR(aa)=Pr(A|aa)/Pr(A)=(Pr(A|aa)/Pr(A|bb))/(Pr(A)/Pr(A|bb))=r²/(Pr(aa)r²+Pr(ab)r+Pr(bb))=r²/(p²r²+2pqr+q²)=r²/R

“p” and “q” are the allele frequencies of “a” and “b” respectively.

Likewise, RR(ab)=r/R and RR(bb)=1/R.

The allele frequency estimates are obtained from the scientific publications that report the odds-ratios and from the HapMap database.

Risk Calculations—Combining the Risk from Multiple Markers

When genotypes of many SNP variants are used to estimate the risk for an individual, unless otherwise stated, a multiplicative model for risk is assumed. This means that the combined genetic risk relative to the population is calculated as the product of the corresponding estimates for individual markers, e.g. for two markers g1 and g2:

RR(g1,g2)=RR(g1)RR(g2)

The underlying assumption is that the risk factors occur and behave independently, i.e. that the joint conditional probabilities can be represented as products:

Pr(A|g1,g2)=Pr(A|g1)Pr(A|g2)/Pr(A) and Pr(g1,g2)=Pr(g1)Pr(g2)

Risk Calculations—Adjusted Life-Time Risk

Finally, the lifetime risk of the individual is derived by multiplying the overall genetic risk relative to the population with the average life-time risk of the disease in the general population of the same ethnicity and gender and in the region of the individual's geographical origin. As there are usually several epidemiologic studies to choose from when defining the general population risk, studies that are well-powered for the disease definition that has been used for the genetic variants are retained.

Social Media

The method of the present invention allows for exploring and tagging a personal genome for enhanced interpretation and actionable feedback. In one embodiment, the step of exploring and tagging personal genome information uses social media. Social media employ web- and mobile-based technologies to support interactive dialogue and take on many different forms including internet forums, blogs, and social networks. They enable to retrieve or spread information, allow for marking information, aid in classification, allow for categories, allow as a search mechanism, and link to datasets. In one particular embodiment, the method for managing the personal genome information of a user provides for a plug-in ability for social media networking.

Many blog systems allow users to add free-form tags to a post, along with placing the post into categories. Advantages in tagging a genome include (a) the possibility to retrieve and see how many other users have like tags (that same variation); (b) the generation or provision of sets of commonly associated tags; (c) like tags within a network can be assessed for variant (e.g., SNP) enrichments, potentially revealing unknown trait linkages and allowing reverse phenotyping.

“Tagging a personal genome sequence” means annotating a personal genome with fixed vocabulary relevant to personal features (physical, behavior, . . . ) and allows for accessing more relevant and actionable information in a fast way. Typically, the rsid will be the identifier in a tag. Social media such as Twitter enable each variant sequence to become a hashtag, viewing in real time the reaction from, for instance, a population carrying one or more identical sequence variants. This is particularly beneficial to find out what other users are tweeting about the same topic, such as known variants, as well as variants that seem unique to that person and for which browsing public genome information did not spot public variants at that position. Thus, in one embodiment of the present invention, one, two, three or more personal genome variants are tagged and shared through the use of social media. In a preferred embodiment, the personal genome variant is marked with a hashtag and shared in the form of a hashtag. In a preferred embodiment, the social media for sharing is Twitter and the variant is shared as a hashtag. On Twitter, when a hashtag becomes extremely popular, it will appear in the Trending Topics area of a user's homepage.

‘Hashtag’ is any combination of characters led by a hash sign. A hashtag typically contains the “#” symbol plus a topic or word. For instance, “#Rs11650354” will retrieve information about SNP rs11650354 associated with allergic asthma.

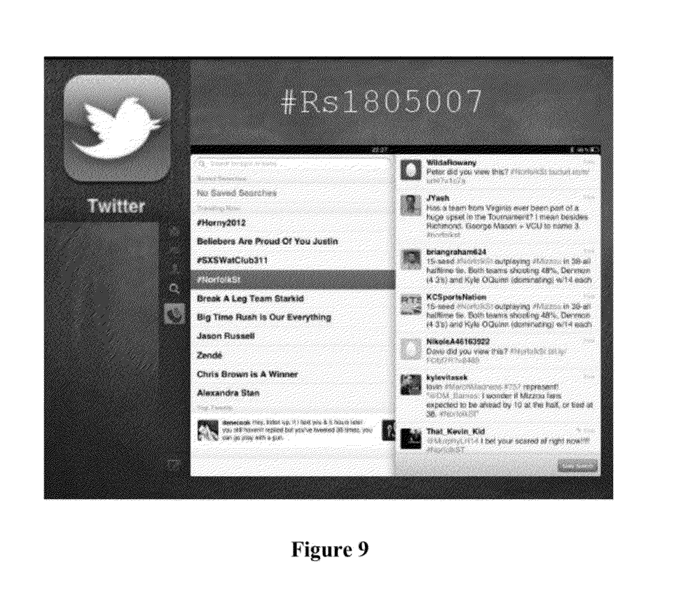

Any hashtag, if promoted by enough individuals, can trend and attract more individual users to discussion using the hashtag and become part of or link to an information database or category. As an example, FIG. 9 is a representation of a visual display showing Trending News for #Norfolkst and spots tweets for that relevant hashtag. A hastag #Rs 1805007 can be used for browsing Twitter in a similar way to gather information on SNP Rs1805007.

In order to get to more relevant and actionable information faster, every SNP can become a hashtag on twitter and can be followed using the App myWobble. Other share options include, +1, like, . . . , genome blogging and allow to capture social media users besides twitter users.

Genome Blogging

Personal genome sequence information should not be vulnerable to disclosure that could lead to discrimination. Therefore, the method or device may apply certain track before sharing information. For instance, users should share information about their genome without sharing their identity. Users should not share a complete wobble set, or never share a set of tags that allow unique identification.

Personalized 3D Prints of Proteins

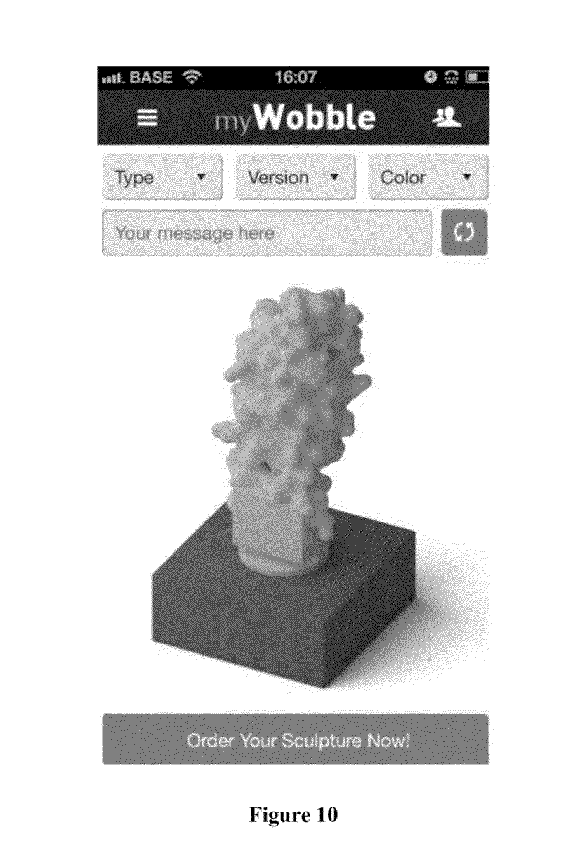

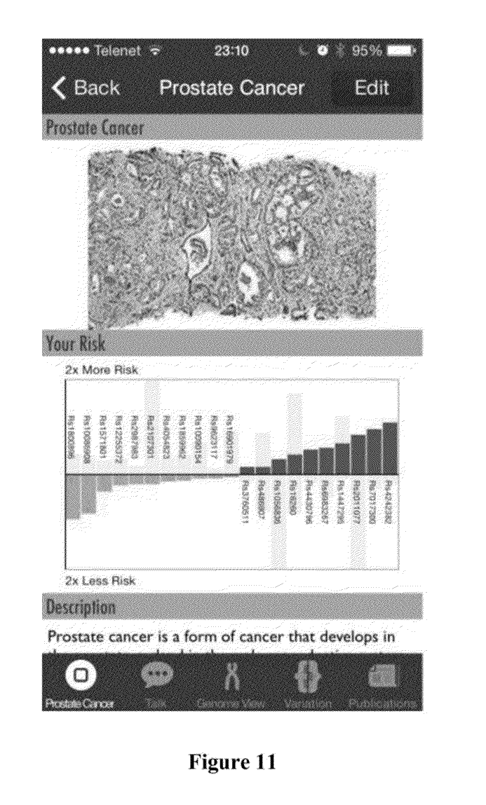

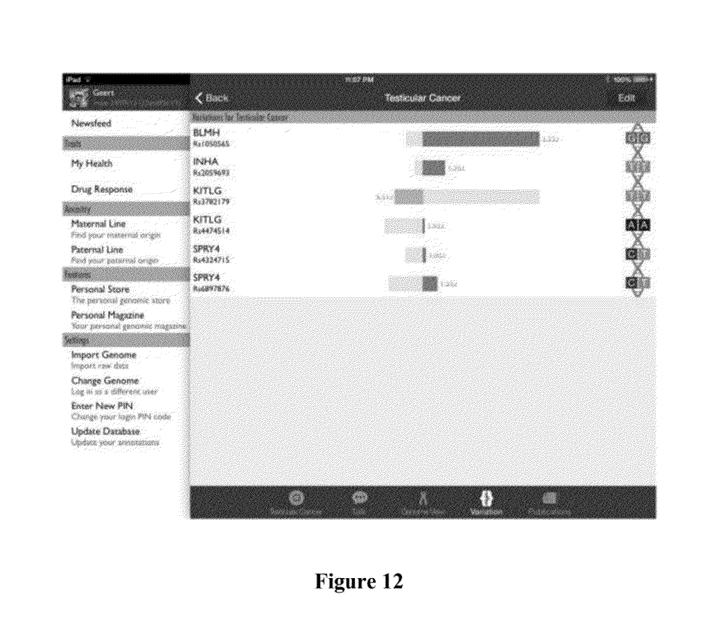

Based on the personal data/variations, the user is allowed to 3D print his own protein sets. As an example, FIG. 10 is a representation of a visual display of a window depicting the 3D structure of a proteins based on the person's genome variations. The app allows for a selectable link to order a 3D printed version of a person own proteins. They can be printed in different materials and sized and customized by adding text (name) and selecting different finishings. They can be used as art object, jewelry and even furniture. The 3D information for a person's SNP are converted from public databases if 3D information for the particular SNP is available, if not the 3D structure of the wild type protein is used and the location of the non-synonymous SNP is visually shown by applying a different color and/or shape and/or symbol and/or text.

Personalized Pharmacy

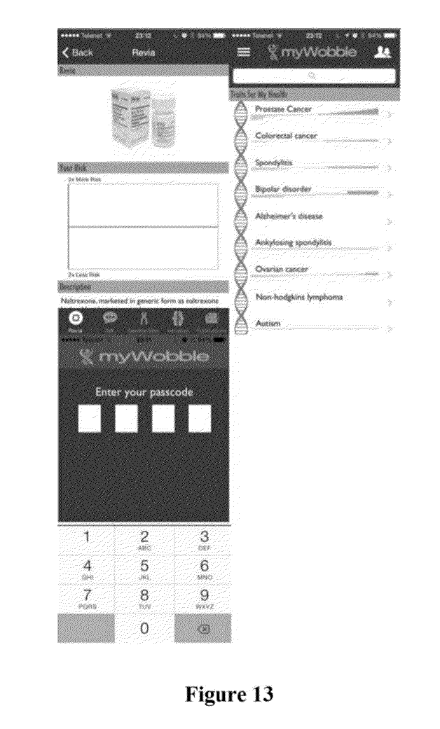

The app will allow to upload metabolic SNPs, which are know to be implicated for the metabolism of sold drugs (in the label), to a central health care supported repository. FIG. 13 (left) is a representation of personal pharmacy. When caretakers (pharmacy, doctor) prescribe or hand medication to the person, his relevant SNPS, upon his approval can be consulted to adjust the dose and/or change medication.

Personalized Magazine

Based on a person's genotype and phenotype (traits) a personalized magazine is compiled and regularly updated. It gathers news items related a person's genotypic data and/or traits relevant for each individual. In essence it is a seaded “zite” approach presented as a “flipboard”.

1. A method for managing personal genome information from a user on a mobile device, which method comprises the steps of:
receiving personal genome sequence data at the mobile device from the user;
comparing the personal genome sequence data to a reference genome sequence data to identify one or more sequence variants from the personal genome sequence data;
assigning one or more sequence variants from the personal genome sequence data to categories of hierarchical lists; and
providing one or more visual displays to the user based on the assignment of the sequence variants in the categories of hierarchical lists.

2. The method according to claim 1, wherein the step of receiving comprises uploading or importing personal genome sequence data.

3. The method according to claim 1, wherein the personal genome sequence is received via encrypted communication and optionally stored in encrypted format in the mobile device.

4. The method according to claim 1, further comprising:
searching the personal genome sequence data for the presence of sequence variants all or not associated with a phenotypic condition or trait.

5. The method according to claim 1, further comprising:
comparing one or more sequence variants from the personal sequence data to sequence variant information all or not associated with a phenotypic condition or trait.

6. The method according to claim 5 wherein the sequence variant information is available from, or made available through, one or more public sources, databases, scientific publications, scientific reports, or social media.

7. The method according to claim 1, further comprising calculating risk from odds-ratios between two groups of population.

8. The method according to claim 7, wherein the risk for developing a disease or trait is calculated.

9. The method according to claim 1, further comprising:
receiving an annotation associated with personal genome sequence data; and
sharing personal genome sequence data.

10. The method according to claim 9, wherein one or more sequence variants within the personal genome sequence data receives an annotation to improve a depth of the analysis.

11. The method according to claim 10, wherein one or more sequence variants within the personal genome sequence data receives a annotation to improve risk variation assessment.

12. The method according to claim 1, further comprising presenting enhanced interpretation of the one or more sequence variants.

13. The method according to claim 1, further comprising presenting actionable feedback regarding the one or more sequence variants at the mobile device.

14. The method according to claim 9, wherein one or more sequence variants are annotated with one or more hashtags.

15. The method according to claim 9, wherein personal genome sequence data is shared using social media.

16. The method according to claim 1, wherein the personal genome sequence data comprises at least one single-nucleotide polymorphism (SNP) or variant sequence.

17. The method according to claim 16, wherein the SNP or variant sequence is shared in the form of a hashtag.

18. The method according to claim 6, wherein the public source is twitter.

19. The method according to claim 1, wherein assigning one or more sequence variants from the personal sequence data to categories of hierarchical lists is based on local statistics applied to variants, traits, and diseases.

20. The method according claim 19, wherein the categories of hierarchical lists involve tweets about a variant.

21. The method according to claim 20, wherein the categories of hierarchical lists include a most recent one to twenty relevant tweets about a variant.

22. The method according to claim 1, wherein the mobile device is a smartphone.

23. The method according to claim 1, further comprising ordering a sequence analysis.

24. The method according to claim 23, wherein the step of ordering comprises selecting a genomic provider or a technology for sequence analysis.

25. The method according to claim 1, wherein the personal genome sequence data is a variation file.

26. The method of claim 1, further comprising:
receiving a selection of an identified sequence variant;
acquiring 3D information for a protein encoded by the selected sequence variant; and
enabling fabrication of a physical 3D structure according to the acquired 3D information.

27. The method of claim 1, wherein the reference genome sequence data comprises an identification of at least one metabolic single-nucleotide polymorphism (SNP) and further comprising:
preventing a visual indication of at least one identified sequence variant representing a metabolic SNP;
wherein the presentation is consulted during the prescription or acquisition of pharmaceuticals.

28. The method of claim 1, further comprising;
gathering on-line digital content related to at least one identified sequence variant;
compiling a personalized digital magazine of genetic information from the gathered digital content;
presenting the gathers digital content in at least one visual display.

29. A mobile device for managing personal genome information, the mobile device comprises:
a central processing unit configured to execute computer readable code;
a graphical display operated by the central processing unit to present a user interface; and
a memory programmed with computer readable code and, the memory communicatively connected to the central processing unit such that the computer readable code is accessed and executed by the central processing unit causing the mobile device to receive personal genome sequence data, compare the personal genome sequence data to a reference genome sequence data, identify one or more sequence variants, assign one or more of the identified sequence variants from the personal sequence data to categories of hierarchical lists, and operate the graphical display to present one or more visual displays of one or more of the identified sequence variants based upon the assignment of the sequence variants in the categories of hierarchical lists.

30. A computer program product on a non-transient computer readable medium programmed with computer readable code that upon execution by a computer processor causes the processor to:
receive personal genome sequence data,
compare the personal genome sequence data to a reference genome sequence data;
identify one or more sequence variants;
assign one or more of the identified sequence variants from the personal sequence data to categories of hierarchical lists; and
present one or more visual displays of one or more of the identified sequence variants based upon the assignment of the sequence variants in the categories of hierarchical lists.
